(19) United States
(12) Patent Application Publication
(10) Pub. No.: US 2017/0072435 A1
(43) Pub. Date: Mar. 16, 2017

(54) APPARATUS AND METHOD FOR SEPARATING CREMATED REMAINS

(71) Applicant: Sheldon B. Goldner, Barrington, IL (US)

(72) Inventor: Sheldon B. Goldner, Barrington, IL (US)

(21) Appl. No.: 14/851,364

(22) Filed: Sep. 11, 2015

(51) Int. Cl. B07B 1/46; B07B 13/16

(52) U.S. Cl. CPC B07B 1/46; B07B 13/16

(57) ABSTRACT

Embodiments of the invention provide an apparatus and method for separating cremated remains utilizing a base having side walls and a bottom wall, a receptacle positioned on the bottom wall of the base, a hopper supported by the at least two side walls of the base and having a first opening at a first end of the hopper and a second opening at a second end of the hopper, the first opening having a cross-sectional area that is larger than a cross-sectional area of the second opening; and a screen having a perimeter, wherein the perimeter is removably received within the first opening of the hopper and the second opening of the hopper is in communication with the receptacle.

### BACKGROUND

Cremation is an increasingly popular post-funeral rite that is an alternative to the internment of a body in a coffin or casket. Cremated remains may be buried or interred in cemeteries or memorial sites, or they may be retained by relatives or dispersed in various ways. After cremation, cremated remains are customarily returned to the next of kin in different manners, but are typically kept in an urn, stored in a special memorial building, buried in the ground at a number of locations, or sprinkled at a special location.

After cremation has occurred, the remains are mostly dry calcium phosphates with some minor materials such as salts of sodium and potassium. However, there may be other extraneous materials, such as bone spurs, unprocessed bone fragments, dental fillings, components of surgical implants such as hip replacements, or other extraneous materials. After the remains are processed, larger extraneous materials (e.g., surgical implants) can be manually removed, but smaller extraneous materials are currently not processed in any special way and are placed in the urn with the other cremated materials.

The processing of cremated remains is an important and solemn task which requires the utmost care and diligence in ensuring that the cremated remains are properly provided to the next of kin without the aforementioned pieces of extraneous materials. While any number of devices exist that are directed to various aspects of cremation including the processing of cremated remains, there is a need for a cost effective, durable, and efficient mechanism which would easily assist a cremated remains processor with the task of separating the cremated remains from other extraneous materials.

### SUMMARY

In one aspect of the invention, an apparatus for separating cremated remains may comprise a base having a bottom wall and at least two side walls. The apparatus may further comprise a hopper supported by the at least two side walls of the base and having a first opening at a first end of the hopper and a second opening at a second end of the hopper, the first opening having a cross-sectional area that is larger than a cross-sectional area of the second opening. The apparatus may further include a screen having a perimeter, wherein the perimeter is removably received within the first opening of the hopper. The second opening of the hopper may be in communication with the base.

In some embodiments, a door may be disposed within the second opening to selectively open and close communication between the hopper and the base.

In some embodiments, a receptacle station may be formed within the bottom wall of the base and disposed beneath the hopper to receive a receptacle.

In some embodiments, the receptacle station may be comprised of at least one rail disposed to receive the receptacle.

In some embodiments, the receptacle station may be comprised of at least two rails, the receptacle has a rectangular base, and the at least two rails are in communication with at least two sides of the rectangular base.

In some embodiments, the hopper may be made of stainless steel.

In some embodiments, the screen may be made of woven stainless steel.

In some embodiments, the woven stainless steel may be formed of wires having a diameter of about 0.035 inches.

In some embodiments, the hopper may include a first section forming the first opening, the first section formed of at least three walls and a second section adjacent the second opening, the second section having at least three sides and having a pyramidal shape.

In another aspect of the invention, an apparatus for separating cremated remains may comprise a base having a receptacle receiving station and a receptacle configured to be inserted and withdrawn from the receptacle receiving station. The apparatus may further comprise a hopper operatively connected to a portion of the base and a screen disposed within a portion of the hopper.

In some embodiments, the base may further comprise a bottom and at least two sides wherein the at least two sides are connected to the hopper.

In some embodiments, the hopper may be made of one of austenitic stainless steel, martensitic stainless steel, ferritic stainless steel, duplex stainless steel, or precipitation hardening stainless steel.

In some embodiments, the base may be made of one of austenitic stainless steel, martensitic stainless steel, ferritic stainless steel, duplex stainless steel, or precipitation hardening stainless steel.

In some embodiments, the receptacle station may comprise at least two rails, wherein the rails are punched out of the base.

In some embodiments, the screen may comprise a grasp mechanism and the screen has a perimeter that is in detachable communication with the hopper.

In some embodiments, the base may further comprise a bottom wall and at least two side walls, the hopper may be disposed in an overturned pyramidal shape having four walls, and a planar flange may be attached to each of the four walls.

In some embodiments, the bottom wall may at least partially form the receptacle station and the receptacle station is further formed by at least two punched out pieces of the bottom wall.

In another aspect of the invention, a method of separating cremated remains may include the steps of providing a receptacle on a base disposed beneath a hopper and pouring cremated remains through a screen positioned within the hopper. The method may further include the steps of receiving a first portion of the cremated remains having a smaller dimension within the receptacle and collecting a second portion of the cremated remains having a larger dimension within the screen.

In some embodiments, the screen may be made of woven stainless steel.

In some embodiments, the receptacle may be an urn.

### DESCRIPTION OF THE DRAWINGS

FIG. 1 illustrates a top, front isometric view of an apparatus for separating cremated remains, including an ash receiving receptacle, according to one embodiment of the invention.

FIG. 2 illustrates a top, front isometric view of the apparatus depicted in FIG. 1 wherein the ash receiving receptacle has been removed.

FIG. 3 illustrates a top, rear isometric view of the apparatus in FIG. 1.

FIG. 4 illustrates a top isometric view of the apparatus in FIG. 1.

FIG. 5 illustrates an exploded isometric view of the apparatus in FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

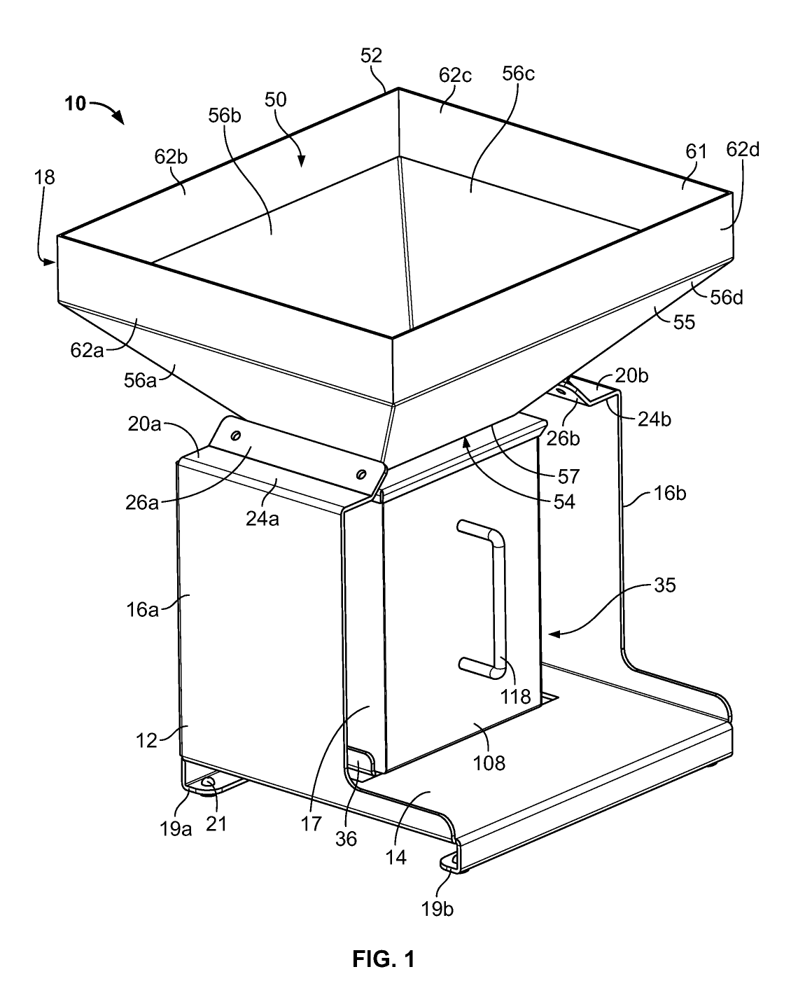

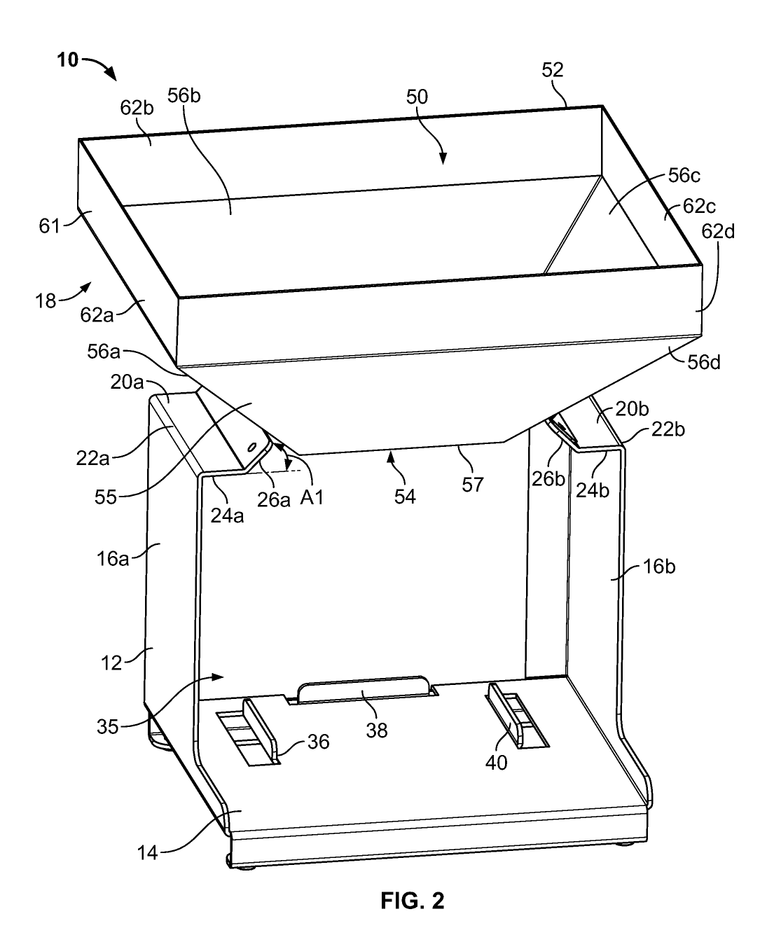

FIG. 1 illustrates an apparatus 10 for separating cremated remains according to an exemplary embodiment of the invention. The apparatus 10 can include a base 12 having a bottom wall 14, a first side wall 16a, and a second side wall 16b. The apparatus 10 may further include one or more legs 19a, 19b for supporting the base 12. The legs 19a, 19b may include one or more stoppers 21 to stabilize and/or prevent the apparatus 10 from moving. In an exemplary embodiment, the apparatus 10 may further include a receptacle 17 removably positioned on the bottom wall 14 at least partially between the first side wall 16a and the second side wall 16b. As shown in FIG. 1, the apparatus 10 includes a hopper 18 supported by the first side wall 16a and the second side wall 16b. More particularly, each of the first and second side walls 16a, 16b of the base 12 may include a support member 20a, 20b, respectively, extending from edges 22a, 22bthereof that connect to and support the hopper 18. Each support member 20a, 20bmay include one or more walls, for example, a first support wall 24a, 24bthat is generally perpendicular to each of the first and second side walls 16a, 16b, respectively, and a second support wall 26a, 26b that is angled with respect to the first support wall 24a, 24b, respectively. The second support wall 26a, 26b may be disposed at an angle A1 (FIG. 2) of between about 30 and about 75 degrees with respect to the first support wall 24a, 24b. In one embodiment, one or more brackets 28b may be attached by screws, bolts, or any other suitable fastener to the second support wall 26a, 26b and the hopper 18.

In an exemplary embodiment, the bracket 28b is an L shaped bracket having a lateral portion 30band a vertical portion 32b. The lateral portion 30bof the bracket 28a, 28b is attached by screws, bolts, or any other suitable fastener to the second support wall 26b and the vertical portion 32bis attached by screws, bolts, or any other suitable fastener to an angled portion 34bof the hopper 18. In other embodiments, the support members 20a, 20bmay be attached to the hopper 18 in any other suitable manner. While only one bracket 28b is shown, a second bracket identical to the bracket 28b may be attached between the first support wall 26a and the hopper 18.

The hopper 18 may include a first opening 50 at a first end 52 of the hopper 18 and a second opening 54 at a second end 57 of the hopper 18. In an exemplary embodiment, the first opening 50 has a cross-sectional area that is larger than a cross-sectional area of the second opening 54. In an exemplary embodiment, the hopper 18 includes a lower section 55 having an overturned pyramidal shape having four angled sides 56a, 56b, 56c, and 56d and an upper section 61 formed of flanges 62a, 62b, 62c, and 62d extending upwardly from the angled sides 56a, 56b, 56c, 56d. In this embodiment, when the apparatus 10 is in an upright position, the angled sides 56a, 56b, 56c, 56d are angled inwardly and downwardly from the flanges 62a, 62b, 62c, 62d in a direction from the flanges 62a, 62b, 62c, 62d to the second opening 54, which allows the cremated remains to fall toward the second opening 54 of the hopper 18 with the assistance of gravity.

In an exemplary embodiment, the hopper 18 is comprised of the four angled sides 56a, 56b, 56c, and 56d that generally form a trapezoidal shape. The angled sides 56a, 56b, 56c, and 56d together form an upside down pyramid shape wherein the tip of the pyramid is removed to form the second opening 54. The second opening 54 may have a square or rectangle shaped cross section. It should be noted that the angled side 56a, 56b, 56c, and 56d may be separate pieces or may be formed by a single piece. In other exemplary embodiments, the hopper 18 may include any suitable number of angled sides, for example, one, two, three, or any other suitable number. Still further, the first and second openings 50, 54 may have any suitable shape.

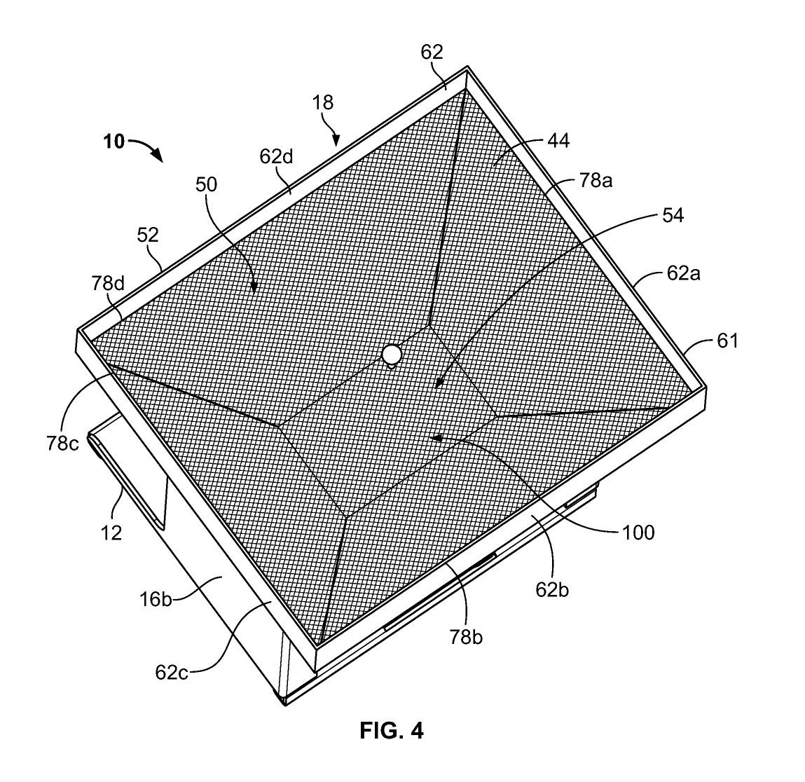

As seen in FIG. 4, a cross-sectional area of the first opening 50 is greater than the cross-sectional area of the second opening 54. As would be apparent to one of ordinary skill in the art, adjusting either the upper area or the lower area would alter the slope Θ of the angled sides 56a, 56b, 56c and 56d. Alterations to the upper or lower area may be desirable to adjust the space taken up by the apparatus 10 or to increase or decrease the slope Θ depending on the desired results of the user.

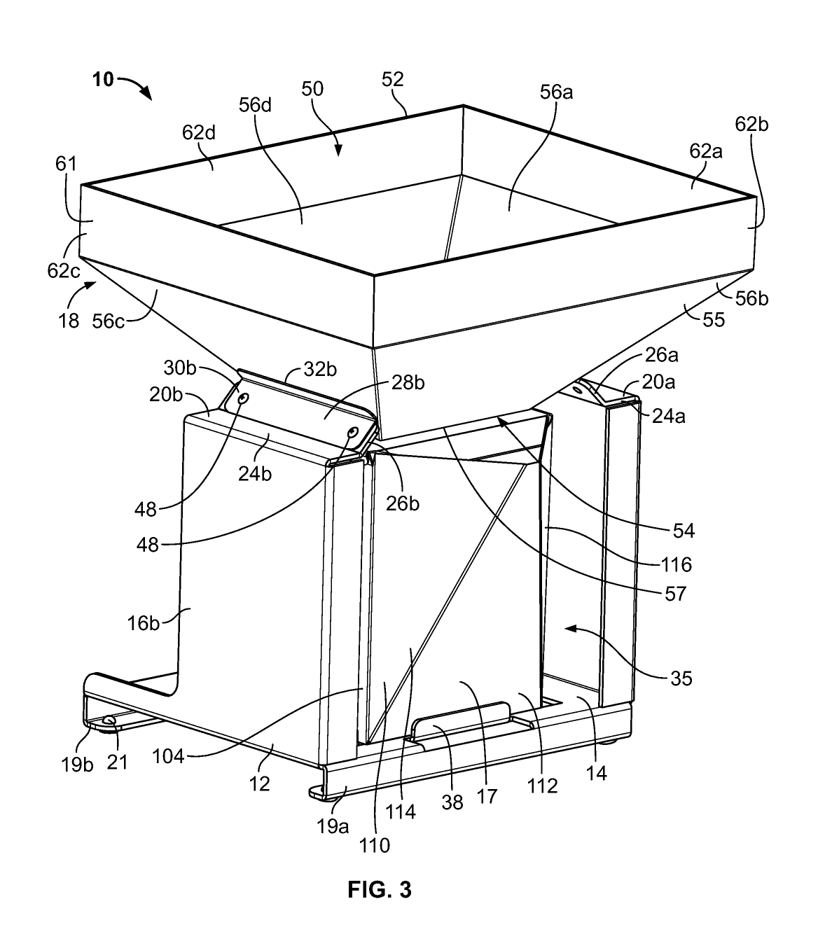

As seen in FIG. 3, the hopper 18 is fastened to the base 12 with fasteners 48. In an exemplary embodiment, the hopper 18 is fastened to the first side wall 16a (or a bracket) and/or the second side wall 16b (or the bracket 28b) with the fasteners 48. The hopper 18 may also be fastened to allow for detachment from the first side wall 16a and the second side wall 16b. In alternative embodiments, the hopper 18 may be attached to a single side wall 16a, 16b (or bracket) or more than two side walls (for example, if the base 12 also included a rear and/or a front wall).

As further depicted in FIG. 3, when engaged, the receptacle 17 is in communication with a receptacle station 35. In an exemplary embodiment, the receptacle station 35 has a first rail 36, a second rail 38 and a third rail 40. The second rail 38 is oriented in an orthogonal direction relative to the first rail 36 and the third rail 40, which are parallel with respect to one another. The first rail 36, second rail 38, and third rail 40 hold the receptacle 17 in place until a user removes the receptacle 17 from the apparatus 10. More particularly, the first and third rails 36, 40 allow for sliding movement of the receptacle into the receptacle station 35 and the second rail 38 prevents further movement of the receptacle into the receptacle station 35. In an exemplary embodiment of the apparatus 10 and as shown in FIG. 2, the receptacle station 35 includes the first rail 36, the second rail 38, and the third rail 40 which operate to position and confine the receptacle 17 in a position directly below the second opening 54 of the hopper 18 to receive separated cremated remains.

While the receptacle station 35 is described as being defined by rails 36, 38, 40, the receptacle station 35 may be defined by any combination of one or more rods, poles, rails, struts, any other suitable barrier, or by the side rails 16a, 16b. The receptacle station 35 may further include a depression in the bottom wall 14 of the base 12 to receive the receptacle 17. Still further, a lock, latch, or any other suitable retention mechanism may be utilized to lock the receptacle 17 in position during dispensing of cremated remains into the receptacle.

The first rail 36, second rail 38, and third rail 40 may be formed out of the material of the bottom wall 14 of the base 12 or may be formed of a separate material and fastened to the bottom wall 14. One or all of the first rail 36, second rail 38, and third rail 40 may be punched out of the bottom wall 14, as best seen in FIG. 2. Alternatively, the first rail 36 and the third rail 40 may be a part of the side walls 16a, 16b and the second rail 38 may be utilized to restrain the back of the receptacle 17. The receptacle station 35 may also be defined by only one rail. For example, a single circumferential rail is also contemplated which may receive a circular receptacle 17. Any combination of rails is contemplated to receive the receptacle 17 beneath the hopper 18 depending on the configuration of the base 12, a shape of the receptacle 17, and/or any other features of the apparatus 10.

As shown in FIG. 4, the apparatus 10 also includes a screen 44 situated in the upper section 61 adjacent the first opening 50 of the hopper 18. In an exemplary embodiment, the screen 44 comprises side edge members 78a, 78b, 78c, and 78d that may connect to one another and define a perimeter of the screen 44 and provide stability such that the screen is generally planar and does not bend or depress during use. The screen 44 may have a same cross-sectional area 76 as the upper section 61 of the first opening 50 or a cross-sectional area slightly less than that of the upper section 61. The screen may alternatively have a cross sectional area 76 that is the same as any cross sectional area defined by the angled sides 56a, 56b, 56c and 56d of the hopper 18 between the upper section 61 and the second opening 54. In an exemplary embodiment, the cross-sectional area of the screen 44 is between about 100 square inches and about 200 square inches. In a further exemplary embodiment, the cross sectional area of the screen is between about 140 square inches and about 170 square inches. In another exemplary embodiment, the cross sectional area of the screen 44 is between about 150 square inches and about 165 square inches.

The screen 44 may further comprise a grasp mechanism 46 such as a knob, handle, haft, shank, grip, or any other suitable grasp mechanism that may allow a user to selectively remove the screen 44 from the hopper 18, for example, to remove extraneous material therefrom. In an exemplary embodiment, the screen has a size and perimeter that fits snuggly within the upper section 61 of the hopper 18 and which is in detachable communication with the hopper 18. In an exemplary embodiment, the screen 44 may be longitudinally restrained (in a direction of flow of remains into the apparatus 10) by brackets, latches, the angled sides 56a -56d, or in any other suitable manner.

In a further exemplary embodiment, the apparatus 10 may include a door 100 within the second opening 54 to selectively open and close communication between the hopper 18 and the receptacle 17. The door 100 may be attached to the second opening 54 with one or more hinges, via a sliding mechanism, or any other suitable method of attachment.

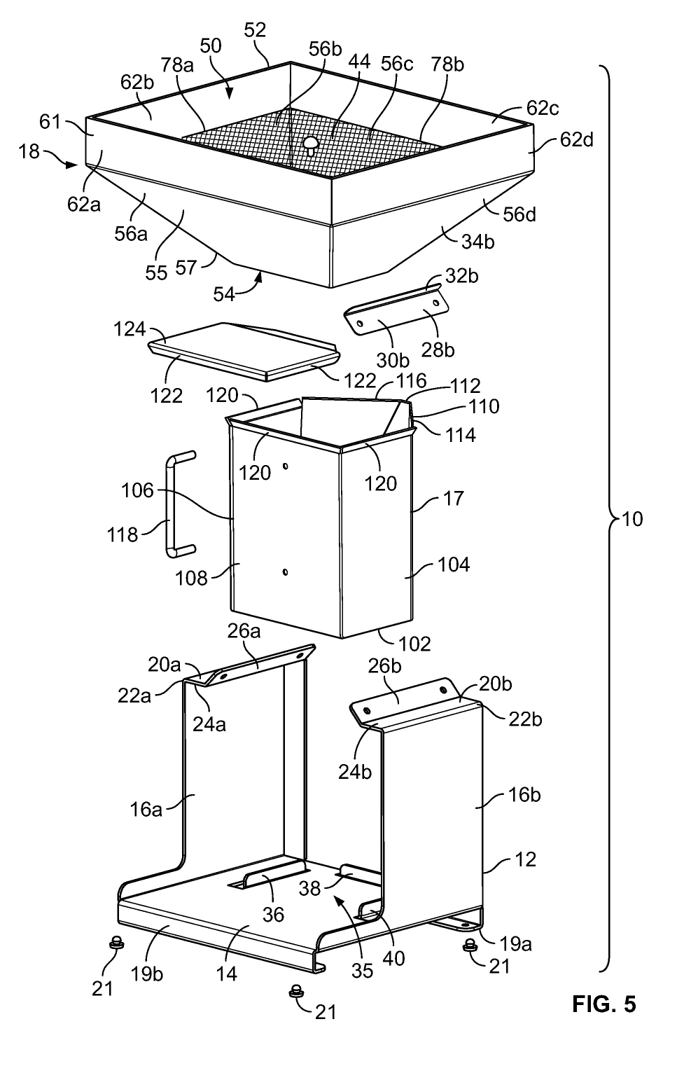

As best seen in FIG. 5, the receptacle 17 may be in the form of, for example, a pitcher. The receptacle may include a bottom wall 102, first and second opposing side walls 104, 106, a rear wall 108, and a front spout 110. Referring to FIG. 3, the spout 110 may be formed of a first angled surface 112 that is angled outwardly from the bottom wall 102 and second and third angled surfaces 114, 116 that are angled from the side walls 104, 106 to the first angled surface 112. The angled surfaces 112, 114, 116 form the spout 100 from which cremated remains within the receptacle 17 may be poured. The receptacle 17 may further include a handle 118 extending from the rear wall 108 (or any other suitable surface) for holding and pouring cremated remains therefrom. As best seen in FIG. 2, the receptacle 17 may further include an outturned lip 120 extending from top edges of the side walls 104, 106 and the rear wall 108. The outturned lip 120 interacts with an in turned lip 122 on a lid 124 that may be slid onto a top portion of the receptacle 17 to at least partially enclose the cremated remains within the receptacle 17. The lid 124 may be removed before the receptacle 17 is inserted into the apparatus 10 (to create a large are through which the cremated remains may be dispensed into the receptacle 17) and replaced when removed from the apparatus 10 (for pouring the cremated remains, for example, into a separate bag or container).

The hopper 18 may be made from any malleable material known to those in the art. For instance, the hopper 18 may be made of any kind of stainless steel including austenitic stainless steel, martensitic stainless steel, ferritic stainless steel, duplex stainless steel, or precipitation hardening stainless steel. The screen 44 may also be made of any kind of stainless steel including austenitic stainless steel, martensitic stainless steel, ferritic stainless steel, duplex stainless steel, or precipitation hardening stainless steel. In an exemplary embodiment of the apparatus 10 the screen 44 is made of woven steel, however in another embodiment the screen may be made from any other suitable metal composition and may be woven, knitted, welded, expanded, photo-chemically etched, electroformed, or formed by any other suitable means known to those in the art. In another embodiment, the screen 44 or the hopper 18 may be made from a polymer such as polypropylene, polyethylene, nylon, polyvinyl chloride (PVC), polytetrafluoroethylene (PTFE), or any other suitable polymer. The hopper 18 and/or screen 44 may also be formed of any combination of the above-noted materials.

The apparatus 10 may be used to separate cremated remains from any foreign or extraneous material that may be left over in the cremated remains. The amount and size of the foreign material caught in the screen 44 depends on the mesh size of the screen 44 used during the separation process, which may be selected from any desirable and suitable mesh size. The apparatus 10 is used by first removing the lid 124 on the receptacle and placing the receptacle 17 (or another receptacle) within the receptacle receiving station 25. Next, the pulverized cremated remains, which are retrieved from a processor, are poured through the screen 44 disposed adjacent the first opening 50 at the first end 52 of the hopper 18. After the cremated remains have been poured through the screen 44, the foreign material is collected from the screen 44 and placed in a separate container. The screen 44 is then removed from the first opening 50 and any remaining cremated remains on the inside of the angled side 56a, 56b, 56c and 56d of the hopper 18 are then brushed into the receptacle 17 disposed below the second opening 54. The receptacle 17 is then removed, the lid 124 is replaced, and the receptacle 17 is stored with proper identification. Optionally, the remains may be poured into a separate bag or container for storage thereof.

As seen in FIG. 3, the second opening 54 of the hopper 18 is disposed adjacent to the receptacle 17. While the first opening 50 and the second opening 54 of the hopper 18 are described herein as having particular cross-sectional shapes, other cross-sectional shapes are contemplated. For example, the cross-section of one or both of the upper section 61 and the lower section 55 may be selected from a square, a rectangle, a circle, a triangle, or any other shape that one of ordinary skill in the art may find beneficial for the purposes described herein.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. An apparatus for separating cremated remains comprising:
a base having a bottom wall and at least two side walls;
a hopper supported by the at least two side walls of the base and having a first opening at a first end of the hopper and a second opening at a second end of the hopper, the first opening having a cross-sectional area that is larger than a cross-sectional area of the second opening; and
a screen having a perimeter, wherein the perimeter is removably received within the first opening of the hopper;
wherein the second opening of the hopper is in communication with the base.

2. The apparatus of claim 1, further including a door within the second opening to selectively open and close communication between the hopper and the base.

3. The apparatus of claim 1 further comprising a receptacle station formed within the bottom wall of the base and disposed beneath the hopper to receive a receptacle.

4. The apparatus of claim 3 wherein the receptacle station is comprised of at least one rail disposed to receive the receptacle.

5. The apparatus of claim 3 wherein the receptacle station is comprised of at least two rails, the receptacle has a rectangular base, and the at least two rails are in communication with at least two sides of the rectangular base.

6. The apparatus of claim 1 wherein the hopper is made of stainless steel.

7. The apparatus of claim 1 wherein the screen is made of woven stainless steel.

8. The apparatus of claim 7 wherein the woven stainless steel is formed of wires having a diameter of about 0.035 inches.

9. The apparatus of claim 1 wherein the hopper includes a first section forming the first opening, the first section formed of at least three walls and a second section adjacent the second opening, the second section having at least three sides and having a pyramidal shape.

10. An apparatus for separating cremated remains comprising:
a base having a receptacle receiving station;
a receptacle configured to be inserted and withdrawn from the receptacle receiving station;
a hopper operatively connected to a portion of the base; and
a screen disposed within a portion of the hopper.

11. The apparatus of claim 10 wherein the base further comprises a bottom and at least two sides wherein the at least two sides are connected to the hopper.

12. The apparatus of claim 10 wherein the hopper is made of one of austenitic stainless steel, martensitic stainless steel, ferritic stainless steel, duplex stainless steel, or precipitation hardening stainless steel.

13. The apparatus of claim 11 wherein the base is made of one of austenitic stainless steel, martensitic stainless steel, ferritic stainless steel, duplex stainless steel, or precipitation hardening stainless steel.

14. The apparatus of claim 13 wherein the receptacle station comprises at least two rails, wherein the rails are punched out of the base.

15. The apparatus of claim 10 wherein the screen comprises a grasp mechanism and the screen has a perimeter that is in detachable communication with the hopper.

16. The apparatus of claim 10
wherein the base further comprises a bottom wall and at least two side walls,
wherein the hopper is disposed in an overturned pyramidal shape having four walls, and
wherein a planar flange is attached to each of the four walls.

17. The apparatus of claim 16 wherein the bottom wall at least partially forms the receptacle station and the receptacle station is further formed by at least two punched out pieces of the bottom wall.

18. A method of separating cremated remains comprising:
providing a receptacle on a base disposed beneath a hopper;
pouring the cremated remains through a screen positioned within the hopper;
receiving a first portion of the cremated remains having a smaller dimension within the receptacle; and
collecting a second portion of the cremated remains having a larger dimension within the screen.

19. The method of claim 18 wherein the screen is made of woven stainless steel.

20. The method of claim 18 wherein the receptacle is an urn.
